(19) United States
(12) Patent Application Publication
(10) Pub. No.: US 2026/0302952 A1
(43) Pub. Date: Oct. 1, 2026

(54) Power Conversion Device and Control Method Thereof

(71) Applicant: PowerX Semiconductor Corporation, Hsinchu County (TW)

(72) Inventors: Ke-Horng Chen, Hsinchu County (TW); Ming-Chu Chien, Hsinchu County (TW); Yu-Teng Liang, Hsinchu County (TW); Shi-Jun Zeng, Hsinchu County (TW); Fu-Heng Chen, Hsinchu County (TW)

(73) Assignee: PowerX Semiconductor Corporation, Hsinchu County (TW)

(21) Appl. No.: 19/270,387

(22) Filed: Jul. 15, 2025

(30) Foreign Application Priority Data
Mar. 31, 2025 (TW) 114112344

(51) Int. Cl. H02M 3/158; H02M 1/00; H02M 1/44

(52) U.S. Cl. CPC H02M 3/1582; H02M 1/0009; H02M 1/44

(57) ABSTRACT

The present invention provides a power conversion device and a control method thereof, enabling smooth switching and efficient operation in buck, boost, and buck-boost modes. The device includes an input terminal, an output terminal, first to fourth switching elements, an inductor, a low-side current sensing module, and a control circuit. The control circuit, based on a sensing signal and an output voltage, dynamically adjusts the switching elements to operate in an input voltage grounding state, an input voltage to output voltage state, and an output voltage grounding state to stabilize the output voltage. To overcome the minimum duty cycle limitation, the present invention adjusts the levels of a valley ramp signal or a peak ramp signal to extend the duty cycle of the input voltage grounding state or the output voltage grounding state, and may reduce the operating frequency to minimize switching losses and electromagnetic interference.

### BACKGROUND OF THE INVENTION

### 1. Field of the Invention

The present invention relates to a power conversion device and a control method thereof, particularly to a power conversion device and a control method thereof that effectively overcome the minimum duty cycle limitation, enhance device efficiency, reduce switching losses, and achieve smooth transitions between modes.

### 2. Description of the Prior Art

Conventional four-switch buck-boost converters can convert an input voltage to a desired output voltage and operate across the entire voltage conversion ratio (VCR) range in buck and boost modes, making them widely used in various electronic devices. However, when the input voltage is close to the output voltage, the converter needs to frequently switch between buck and boost operations, which may lead to increased output voltage ripple or reduced system stability, thereby affecting overall performance and power conversion efficiency.

To address the above issues, the prior art has disclosed that the converter may operate in three distinct modes: buck mode, buck-boost mode, and boost mode. Specifically, when the input voltage is greater than the output voltage, the converter operates in buck mode; when the input voltage is approximately equal to the output voltage, the converter operates in buck-boost mode; and when the input voltage is smaller than the output voltage, the converter switches to boost mode. Theoretically, through this control method, the voltage conversion ratio in buck and boost modes can be infinitely extended based on the relationship between the conversion ratio and the duty cycle. However, in practical applications, parasitic effects and the on-time of power switches impose significant limitations on the achievable duty cycle. Therefore, a minimum duty cycle is typically set during the design of the control system to prevent the converter from performing ineffective voltage conversion operations. However, the setting of the minimum duty cycle also limits the achievable voltage conversion ratio, thereby affecting the system flexibility and efficiency.

On the other hand, in conventional continuous conduction mode (CCM) or discontinuous conduction mode (DCM) architectures (commonly referred to as CBB architectures), current-mode control methods are widely adopted to simplify compensation design and enhance system stability. A critical component of current-mode control is current sensing, which plays a vital role in accurately regulating the output voltage and maintaining system stability. Current sensing can generally be categorized into three types: series sensing, high-side sensing, and low-side sensing.

Series current sensing allows the capture of inductor current information in all phases of the converter by directly monitoring the inductor current in each phase, which provides comprehensive feedback information to the control system. However, when series current sensing is performed, all inductor currents must pass through the sensing resistor, resulting in significant conduction losses. Additionally, since the sensing resistor is located at the switching node of the power stage, the current sensing circuit must maintain accuracy for high input common-mode transients. This adds considerable complexity to the circuit design, making it extremely challenging to achieve a precise and robust sensing solution under these conditions.

The second current sensing method is high-side sensing. In this method, during the demagnetization phase of the inductor in buck mode, the inductor current does not pass through the sensing resistor, which helps to reduce conduction losses in buck mode. However, the circuit implementation of high-side sensing requires high-voltage components capable of withstanding high input common-mode voltages, which occupy a larger chip area. Moreover, this method cannot obtain inductor current information during the demagnetization phase and can only use peak current-mode control in all modes. Additionally, the duration of the demagnetization phase is set to a fixed minimum duty cycle. The setting of the minimum duty cycle must consider multiple factors, such as input voltage, inductor current, and cycle length. To ensure normal operation under various conditions, the minimum duty cycle is typically set to a relatively large value. However, this leads to increased inductor current ripple and reduced power conversion efficiency. Larger inductor current ripple increases AC losses and peak currents in the power switches, resulting in higher conduction losses and further limiting achievable efficiency under high-load conditions.

The third current sensing method is low-side sensing, which has the lowest conduction losses because the inductor current passes through the sensing resistor only during specific switching states (e.g., when switches S1 and S3 are on, or switches S2 and S4 are on). However, since inductor current information is available only during these specific intervals, the control system must use peak current-mode control in boost mode and valley current-mode control in buck mode. Additionally, buck mode still requires operation with a fixed minimum duty cycle, which may reduce device efficiency. Furthermore, in buck-boost mode, the regulation of inductor current requires four slope segments to control the voltage, which increases complexity compared to conventional methods (which require only three slope segments). This not only increases switching losses but also exacerbates electromagnetic interference issues.

Despite these limitations, low-side sensing remains attractive due to its minimal impact on conduction losses compared to series and high-side sensing methods, particularly in applications pursuing higher efficiency. Therefore, the industry is actively working to reduce switching losses in low-side sensing during buck-boost mode to further enhance overall device stability and energy efficiency.

### SUMMARY OF THE INVENTION

Therefore, the present invention primarily provides a power conversion device and a control method thereof to improve the shortcomings of the prior art.

An embodiment of the present invention discloses a power conversion device, comprising: an input terminal for receiving an input voltage; an output terminal for providing an output voltage; first, second, third, and fourth switching elements, wherein the first switching element is connected between the input terminal and the second switching element, the second switching element is connected to the third switching element, the fourth switching element is connected between the third switching element and the output terminal, the connection between the first and second switching elements forms a first node, the connection between the third and fourth switching elements forms a second node, and the connection between the second and third switching elements forms a third node; an inductor connected between the first node and the second node; a low-side current sensing module disposed between the third node and a ground terminal, configured to sense the current between the third node and the ground terminal when the first to fourth switching elements operate in an input voltage grounding state and an output voltage grounding state, and to generate a sensing signal; and a control circuit coupled to the low-side current sensing module, the output terminal, and the first to fourth switching elements, configured to dynamically switch the first to fourth switching elements to operate in a boost mode, a buck mode, and a buck-boost mode based on the sensing signal, the duty cycle of the input voltage grounding state, and the duty cycle of the output voltage grounding state, thereby controlling the first to fourth switching elements to convert the input voltage into the output voltage with a target voltage value; wherein, in the buck-boost mode, the control circuit controls the first to fourth switching elements to periodically operate in the input voltage grounding state, the output voltage grounding state, and an input voltage to output voltage state, and extends the duty cycle of the input voltage grounding state or the output voltage grounding state.

Another embodiment of the present invention discloses a control method for a power conversion device, wherein the power conversion device comprises an input terminal for receiving an input voltage, an output terminal for providing an output voltage, first to fourth switching elements, wherein the first switching element is connected between the input terminal and the second switching element, the second switching element is connected to the third switching element, the fourth switching element is connected between the third switching element and the output terminal, the connection between the first and second switching elements forms a first node, the connection between the third and fourth switching elements forms a second node, and the connection between the second and third switching elements forms a third node, and an inductor connected between the first node and the second node. The control method comprises: sensing the current between the third node and a ground terminal when the first to fourth switching elements operate in an input voltage grounding state and an output voltage grounding state, and generating a sensing signal; and dynamically switching the first to fourth switching elements to operate in a boost mode, a buck mode, and a buck-boost mode based on the sensing signal, the duty cycle of the input voltage grounding state, and the duty cycle of the output voltage grounding state, thereby controlling the first to fourth switching elements to convert the input voltage into the output voltage with a target voltage value; wherein, in the buck-boost mode, the first to fourth switching elements are controlled to periodically operate in the input voltage grounding state, the output voltage grounding state, and an input voltage to output voltage state, and are controlled to extend the duty cycle of the input voltage grounding state or the output voltage grounding state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power conversion device.

FIG. 2A, FIG. 2B, and FIG. 2C are schematic diagrams illustrating current directions of the power conversion device of FIG. 1 in different states.

FIG. 3A is a schematic diagram of relevant signals when the power conversion device of FIG. 1 operates in boost mode.

FIG. 3B is a schematic diagram of relevant signals when the power conversion device of FIG. 1 operates in buck mode.

FIG. 3C is a schematic diagram of relevant signals when the power conversion device of FIG. 1 operates in buck-boost mode.

FIG. 4 is a schematic diagram of a power conversion device according to an embodiment of the present invention.

FIG. 5A is a schematic diagram of relevant signals when the power conversion device of FIG. 4 switches from buck mode to buck-boost mode and then enters boost mode.

FIG. 5B is a schematic diagram of relevant signals when the power conversion device of FIG. 4 switches from boost mode to buck-boost mode and then enters buck mode.

FIG. 6 is a schematic diagram of an operational flow of the control circuit of FIG. 4.

FIG. 7A is a schematic diagram of a power conversion device according to an embodiment of the present invention.

FIG. 7B is a schematic diagram of a voltage-to-current converter.

FIG. 8 is a schematic diagram of a control flow according to an embodiment of the present invention.

FIG. 9A and FIG. 9B are comparative schematic diagrams of inductor current.

### DETAILED DESCRIPTION

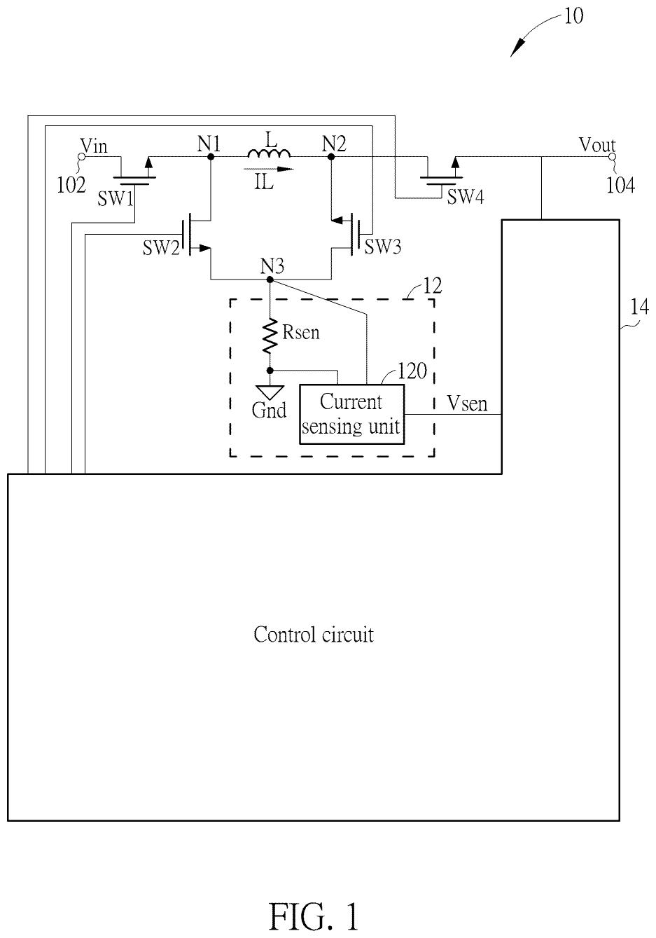

Referring to FIG. 1, which is a schematic diagram of a power conversion device 10. The power conversion device 10 receives an input voltage Vin through an input terminal 102 and provides an output voltage Vout through an output terminal 104. The power conversion device 10 comprises switching elements SW1-SW4, an inductor L, a low-side current sensing module 12, and a control circuit 14. The switching element SW1 is connected between the input terminal 102 and the switching element SW2, the switching element SW2 is connected to the switching element SW3, the switching element SW4 is connected between the switching element SW3 and the output terminal 104, the connection between the switching elements SW1 and SW2 forms a first node N1, the connection between the switching elements SW3 and SW4 forms a second node N2, and the connection between the switching elements SW2 and SW3 forms a third node N3. The inductor L is connected between the first node N1 and the second node N2. The low-side current sensing module 12 is disposed between the third node N3 and a ground terminal Gnd, and comprises a resistor Rsen and a current sensing unit 120. The low-side current sensing module 12 is configured to sense the current between the third node N3 and the ground terminal Gnd and generate a sensing signal Vsen, so as to achieve current monitoring in low conduction loss. The control circuit 14 is coupled to the low-side current sensing module 12, the output terminal 104, and the switching elements SW1-SW4, configured to dynamically adjust the operations of the switching elements SW1-SW4 based on the sensing signal Vsen and the output voltage Vout, to enable the output voltage Vout to approach a target voltage value.

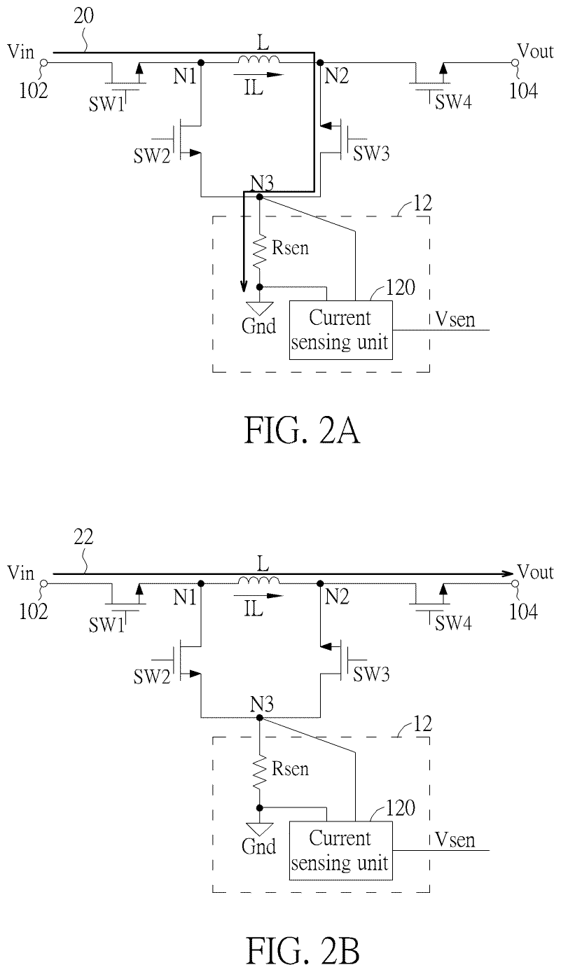

Based on the sensing signal Vsen and the output voltage Vout, the control circuit 14 dynamically adjusts the operations of the switching elements SW1-SW4, and enables the power conversion device 10 to operate in buck mode, boost mode, and buck-boost mode. Additionally, since switches on the same side of the inductor L (e.g., the switching elements SW1 and SW2 on one side of the inductor L, or the switching elements SW3 and SW4 on the other side thereof) cannot be turned on simultaneously to avoid short-circuit damage, the control circuit 14 controls the switching elements SW1-SW4 to operate in three specific states: an input voltage grounding state (Vin_Gnd), an input voltage to output voltage state (Vin_Vout), and an output voltage grounding state (Gnd_Vout). In the input voltage grounding state Vin_Gnd, the control circuit 14 controls the switching elements SW1 and SW3 to be turned on and the switching elements SW2 and SW4 to be turned off, to allow current to flow from the input terminal 102 to the ground terminal Gnd through the switching element SW1 and the inductor L via the switching element SW3, as shown by a direction 20 in FIG. 2A. In the input voltage to output voltage state Vin_Vout, the control circuit 14 controls the switching elements SW1 and SW4 to be turned on and the switching elements SW2 and SW3 to be turned off, to allow current to flow from the input terminal 102 to the output terminal 104 through the switching element SW1 and the inductor L via the switching element SW4, as shown by a direction 22 in FIG. 2B. In the output voltage grounding state Gnd_Vout, the control circuit 14 controls the switching elements SW2 and SW4 to be turned on and the switching elements SW1 and SW3 to be turned off, to allow current to flow from the ground terminal Gnd to the output terminal 104 through the switching element SW2 and through the inductor L via the switching element SW4, as shown by a direction 24 in FIG. 2C. Through periodic switching among these three states, the control circuit 14 controls the power conversion device 10 to operate in buck mode, boost mode, and buck-boost mode, and maintains system stability.

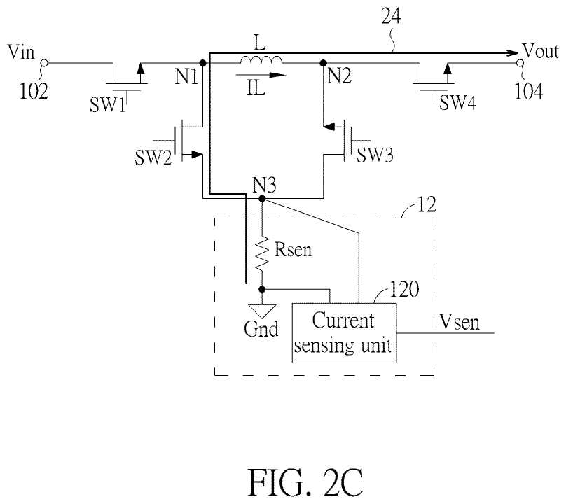

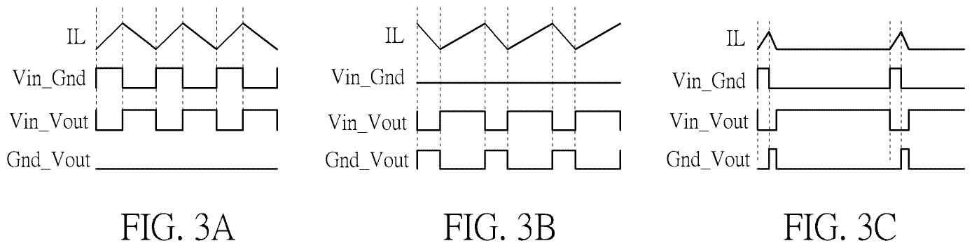

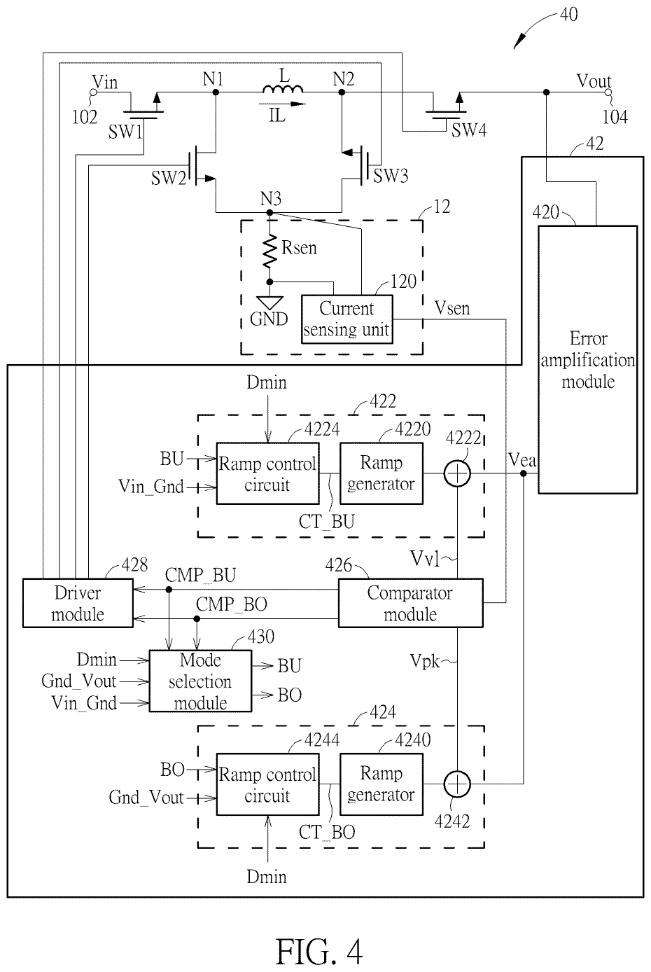

Specifically, when the input voltage Vin is lower than the output voltage Vout, the power conversion device 10 should operate in boost mode, as shown in FIG. 3A. In boost mode, the control circuit 14 controls the switching elements SW1-SW4 to periodically operate in the input voltage grounding state Vin_Gnd and the input voltage to output voltage state Vin_Vout, to control the inductor L to periodically store and release energy. Thus, the inductor current IL increases during the duty cycle of the input voltage grounding state Vin_Gnd and decreases during the duty cycle of the input voltage to output voltage state Vin_Vout, such that the inductor L is in a magnetization phase, to achieve conversion from a lower input voltage Vin to a higher output voltage Vout.

When the input voltage Vin is higher than the output voltage Vout, the power conversion device 10 should operate in buck mode, as shown in FIG. 3B. In buck mode, the control circuit 14 controls the switching elements SW1-SW4 to periodically operate in the output voltage grounding state Gnd_Vout and the input voltage to output voltage state Vin_Vout. Thus, the inductor current IL increases during the duty cycle of the input voltage to output voltage state and decreases during the duty cycle of the output voltage grounding state Gnd_Vout, such that the inductor L is in a demagnetization phase, to achieve conversion from a higher input voltage Vin to a lower output voltage Vout.

When the input voltage Vin is close to the output voltage Vout, to prevent the power conversion device 10 from frequently switching between buck and boost modes, the power conversion device 10 should operate in buck-boost mode, as shown in FIG. 3C, thereby achieving smooth mode transitions. In buck-boost mode, the control circuit 14 controls the switching elements SW1-SW4 to periodically operate in the input voltage grounding state Vin_Gnd, the input voltage to output voltage state Vin_Vout, and the output voltage grounding state Gnd_Vout. Specifically, the inductor current IL increases during the duty cycle of the input voltage grounding state Vin_Gnd, decreases during the duty cycle of the output voltage grounding state Gnd_Vout, and remains constant during the duty cycle of the input voltage to output voltage state Vin_Vout, to enable the power conversion device 10 to smoothly transition between buck and boost modes.

Moreover, since the power conversion device 10 adopts a low-side current sensing architecture, the control circuit 14 can sense the inductor current IL only when the switching elements S1 and S3 or the switching elements S2 and S4 are turned on, i.e., during the aforementioned input voltage grounding state Vin_Gnd or output voltage grounding state Gnd_Vout, and must operate with a minimum duty cycle to prevent the power conversion device 10 from performing ineffective voltage conversion. These limitations reduce the efficiency of the power conversion device 10, increase switching losses, and even exacerbate electromagnetic interference issues.

In this context, the present invention introduces a mechanism to extend the duty cycle of the input voltage grounding state Vin_Gnd (i.e., extending the on-time of the switching elements SW1 and SW3) or the duty cycle of the output voltage grounding state Gnd_Vout (i.e., extending the on-time of the switching elements SW2 and SW4) in buck-boost mode. In other words, when the power conversion device 10 operates in buck-boost mode, the control circuit 14 not only controls the switching elements SW1-SW4 to periodically operate in the input voltage grounding state Vin_Gnd, the input voltage to output voltage state Vin_Vout, and the output voltage grounding state Gnd_Vout, but also extends the duty cycle of the input voltage grounding state Vin_Gnd or the duty cycle of the output voltage grounding state Gnd_Vout. For example, in one embodiment, when the power conversion device 10 switches from buck mode to buck-boost mode and the duty cycle of the output voltage grounding state Gnd_Vout reaches a minimum fixed duty cycle, the control circuit 14 extends the duty cycle of the output voltage grounding state Gnd_Vout. In another embodiment, when the power conversion device 10 switches from boost mode to buck-boost mode and the duty cycle of the input voltage grounding state Vin_Gnd reaches a minimum fixed duty cycle, the control circuit 14 extends the duty cycle of the input voltage grounding state Vin_Gnd. In addition to extending the duty cycle of the input voltage grounding state Vin_Gnd or the duty cycle of the output voltage grounding state Gnd_Vout, in another embodiment, the control circuit 14 may also reduce the operating frequency to extend the duty cycle of the input voltage to output voltage state Vin_Vout, thereby reducing switching losses.

It should be noted that the present invention appropriately extends the duty cycle of the input voltage grounding state Vin_Gnd or the duty cycle of the output voltage grounding state Gnd_Vout in buck-boost mode, to enable the power conversion device 10 to switch more smoothly among boost, buck, and buck-boost modes, thereby reducing instability and output voltage ripple caused by mode switching. It should be understood that the implementation of the present invention is not limited to a specific architecture and may adopt different technical solutions based on system requirements or application scope to achieve the above objectives.

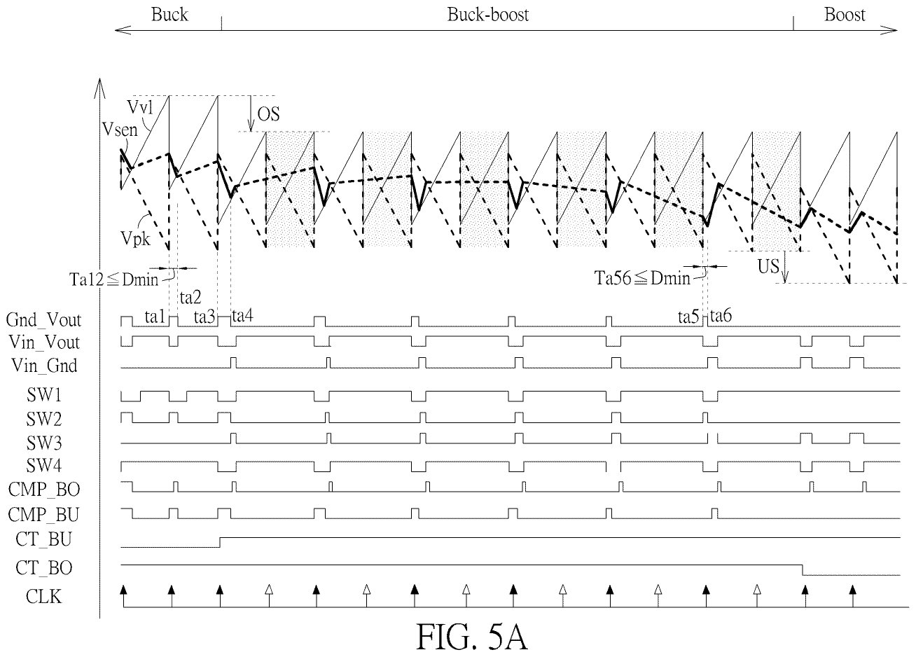

For example, please refer to FIG. 4, which is a schematic diagram of a power conversion device 40 according to an embodiment of the present invention. For clarity, the same components in the power conversion device 40 and the power conversion device 10 are denoted by the same symbols. Additionally, a control circuit 42 of the power conversion device 40 comprises an error amplification module 420, a valley ramp signal generation module 422, a peak ramp signal generation module 424, a comparator module 426, a driver module 428, and a mode selection module 430. The error amplification module 420 is coupled to the output terminal 104 and configured to generate an error amplification signal Vea based on the output voltage Vout and provide the error amplification signal Vea to the valley ramp signal generation module 422 and the peak ramp signal generation module 424. The valley ramp signal generation module 422 generates a valley ramp signal Vvl based on the error amplification signal Vea, the duty cycle of the input voltage grounding state Vin_Gnd, and a mode indication signal BU provided by the mode selection module 430. The peak ramp signal generation module 424 generates a peak ramp signal Vpk based on the error amplification signal Vea, the duty cycle of the output voltage grounding state Gnd_Vout, and a mode indication signal BO provided by the mode selection module 430. It is specifically noted that information (e.g., duty cycle) related to the input voltage grounding state Vin_Gnd may be represented by a signal, which is denoted by, for simplicity, the symbol “Vin_Gnd” and received by the valley ramp signal generation module 422 and the mode selection module 430. Similarly, information (e.g., duty cycle) related to the output voltage grounding state Gnd_Vout may be represented by a signal, which is denoted by, for simplicity, the symbol “Gnd_Vout” and received by the peak ramp signal generation module 424 and the mode selection module 430. The comparator module 426 is coupled to the low-side current sensing module 12, the valley ramp signal generation module 422, and the peak ramp signal generation module 424, and configured to compare the sensing signal Vsen with the valley ramp signal Vvl to generate a valley comparison result CMP_BU and further compare the sensing signal Vsen with the peak ramp signal Vpk to generate a peak comparison result CMP_BO. The driver module 428 is coupled to the comparator module 426 and the switching elements SW1-SW4, and configured to control the on or off states of the switching elements SW1-SW4 based on the valley comparison result CMP_BU and the peak comparison result CMP_BO to achieve voltage conversion. The mode selection module 430 generates the mode indication signals BO and BU based on the duty cycle of the input voltage grounding state Vin_Gnd, the duty cycle of the output voltage grounding state Gnd_Vout, the valley comparison result CMP_BU, and the peak comparison result CMP_BO, to dynamically switch operating modes. Specifically, when the sensing signal Vsen is smaller than both the valley ramp signal Vvl and the peak ramp signal Vpk, the power conversion device 40 should operate in boost mode; when the sensing signal Vsen is greater than both the valley ramp signal Vvl and the peak ramp signal Vpk, the power conversion device 40 should operate in buck mode; and when the sensing signal Vsen is greater than the valley ramp signal Vvl but smaller than the peak ramp signal Vpk, the power conversion device 40 should operate in buck-boost mode.

In other words, in the control circuit 42, the comparator module 426 compares the sensing signal Vsen with the valley ramp signal Vvl and further compares the sensing signal Vsen with the peak ramp signal Vpk, and accordingly controls the on or off states of the switching elements SW1-SW4 through the driver module 428. The valley ramp signal Vvl and the peak ramp signal Vpk, in addition to containing components of the error amplification signal Vea (which is related to the output voltage Vout), are also related to the mode indication signals BU and BO, the duty cycle of the output voltage grounding state Gnd_Vout, and the duty cycle of the input voltage grounding state Vin_Gnd. Thus, when the valley ramp signal generation module 422 and the peak ramp signal generation module 424 generate the valley ramp signal Vvl and the peak ramp signal Vpk respectively, the embodiment of the present invention considers the current operating mode (via the mode indication signals BU and BO), as well as the duty cycles of the output voltage grounding state Gnd_Vout and the input voltage grounding state Vin_Gnd. Consequently, when the duty cycle of the output voltage grounding state Gnd_Vout or the input voltage grounding state Vin_Gnd is too small, for example, smaller than or equal to a minimum fixed duty cycle Dmin, which results in limited voltage conversion efficiency, the embodiment of the present invention can appropriately extend the duty cycle of the output voltage grounding state Gnd_Vout or the input voltage grounding state Vin_Gnd.

Specifically, the valley ramp signal generation module 422 comprises a ramp generator 4220, an adder 4222, and a ramp control circuit 4224, and the peak ramp signal generation module 424 comprises a ramp generator 4240, an adder 4242, and a ramp control circuit 4244. The ramp generator 4220 is configured to generate a ramp signal. The adder 4222 is coupled to the ramp generator 4220, the error amplification module 420, and the comparator module 426, configured to add the ramp signal generated by the ramp generator 4220 to the error amplification signal Vea to generate the valley ramp signal Vvl, and further configured to output the valley ramp signal Vvl to the comparator module 426. The mode selection module 430 generates the mode indication signal BU to indicate whether the power conversion device 40 is operating in buck mode (e.g., BU=1 indicates buck mode, BU=0 indicates non-buck mode, i.e., boost mode). It is specifically noted that when the mode indication signal BU indicates buck mode (BU=1), the mode indication signal BO indicates non-boost mode (BO=0); when the mode indication signal BU indicates non-buck mode (BU=0), the mode indication signal BO indicates boost mode (BO=1). In buck mode, when the mode selection module 430 determines that the duty cycle of the output voltage grounding state Gnd_Vout reaches a minimum fixed duty cycle Dmin and, based on the valley comparison result CMP_BU and the peak comparison result CMP_BO, determines that the sensing signal Vsen is between the valley ramp signal Vvl and the peak ramp signal Vpk, the mode selection module 430 changes the mode indication signal BU (BU=0) to indicate that the power conversion device 40 will transition to boost mode (via buck-boost mode). The ramp control circuit 4224 is coupled to the ramp generator 4220 and further coupled to the mode selection module 430 to receive the mode indication signal BU. When the mode indication signal BU indicates a transition from buck mode to boost mode (i.e., BU changes from 1 to 0), the ramp control circuit 4224 outputs a control signal CT_BU to control the ramp generator 4220 to add an offset signal to the ramp signal, thereby altering the level of the valley ramp signal Vvl (increasing or decreasing depending on the circuit design), which extends the duty cycle of the output voltage grounding state Gnd_Vout. For example, the driver module 428 extends the on-time of the switching elements SW2 and SW4 to extend the duty cycle of the output voltage grounding state Gnd_Vout.

In other words, when the sensing signal Vsen is greater than both the valley ramp signal Vvl and the peak ramp signal Vpk, the power conversion device 40 operates in buck mode (i.e., the mode indication signal BU indicates buck mode), and the switching elements SW1-SW4 periodically switch between the output voltage grounding state Gnd_Vout and the input voltage to output voltage state Vin_Vout, wherein the valley comparison result CMP_BU between the sensing signal Vsen and the valley ramp signal Vvl determines the duty cycle of the output voltage grounding state Gnd_Vout. Subsequently, when the sensing signal Vsen transitions to being between the valley ramp signal Vvl and the peak ramp signal Vpk, it indicates that the power conversion device 40 should first switch to buck-boost mode. At this point, when the duty cycle of the output voltage grounding state Gnd_Vout reaches the minimum fixed duty cycle Dmin, which results in limited voltage conversion efficiency, the ramp control circuit 4224 can (via the control signal CT_BU) control the ramp generator 4220 to add an offset signal to the generated ramp signal, to increase the difference between the sensing signal Vsen and the valley ramp signal Vvl (making it less likely for the sensing signal Vsen to reach the valley ramp signal Vvl), thereby extending the duty cycle of the output voltage grounding state Gnd_Vout.

After the ramp control circuit 4224 controls the ramp generator 4220 to add the offset signal to the ramp signal (i.e., the valley ramp signal Vvl includes the offset signal), when, in buck-boost mode, the sensing signal Vsen is smaller than both the valley ramp signal Vvl and the peak ramp signal Vpk and the ramp control circuit 4244 determines that the duty cycle of the output voltage grounding state Gnd_Vout again reaches the minimum fixed duty cycle Dmin, it indicates that the power conversion device 40 should switch to boost mode. At this point, the valley ramp signal Vvl with the added offset signal remains unchanged, while the peak ramp signal Vpk removes any previously added offset signal (as described below). Only when the mode indication signal BU indicates a transition from boost mode to buck mode (i.e., BU changes from 0 to 1) and the ramp control circuit 4224 determines that the duty cycle of the input voltage grounding state Vin_Gnd reaches the minimum fixed duty cycle Dmin, the ramp control circuit 4224 controls the ramp generator 4220 to remove the offset signal from the ramp signal, thereby restoring the level of the valley ramp signal Vvl.

In short, in the case where the power conversion device 40 switches from buck mode to buck-boost mode, when the duty cycle of the output voltage grounding state Gnd_Vout reaches the minimum fixed duty cycle Dmin, the valley ramp signal Vvl is added with an offset signal. This offset signal is removed from the valley ramp signal Vvl when the power conversion device 40 switches from boost mode back to buck-boost mode for the following transition to buck mode.

On the other hand, the ramp generator 4240 of the peak ramp signal generation module 424 is configured to generate a ramp signal. The adder 4242 of the peak ramp signal generation module 424 is coupled to the ramp generator 4240, the error amplification module 420, and the comparator module 426, configured to add the ramp signal generated by the ramp generator 4240 to the error amplification signal Vea to generate the peak ramp signal Vpk, and further configured to output the peak ramp signal Vpk to the comparator module 426. The mode selection module 430 generates the mode indication signal BO to indicate whether the power conversion device 40 is operating in boost mode (e.g., BO=1 indicates boost mode, BO=0 indicates non-boost mode, i.e., buck mode). In boost mode, when the mode selection module 430 determines that the duty cycle of the input voltage grounding state Vin_Gnd reaches a minimum fixed duty cycle Dmin and, based on the valley comparison result CMP_BU and the peak comparison result CMP_BO, determines that the sensing signal Vsen is between the valley ramp signal Vvl and the peak ramp signal Vpk, the mode selection module 430 changes the mode indication signal BO (BO=0) to indicate that the power conversion device 40 will transition to buck mode (via buck-boost mode). The ramp control circuit 4244 of the peak ramp signal generation module 424 is coupled to the ramp generator 4240 and further coupled to the mode selection module 430 to receive the mode indication signal BO. When the mode indication signal BO indicates a transition from boost mode to buck mode (i.e., BO changes from 1 to 0), the ramp control circuit 4244 outputs a control signal CT_BO to control the ramp generator 4240 to add an offset signal to the ramp signal, thereby altering the level of the peak ramp signal Vpk (increasing or decreasing depending on the circuit design), which extends the duty cycle of the input voltage grounding state Vin_Gnd. For example, the driver module 428 extends the on-time of the switching elements SW1 and SW3 to extend the duty cycle of the input voltage grounding state Vin_Gnd.

In other words, when the sensing signal Vsen is smaller than both the valley ramp signal Vvl and the peak ramp signal Vpk, the power conversion device 40 operates in boost mode (i.e., the mode indication signal BO indicates boost mode), and the switching elements SW1-SW4 periodically switch between the input voltage grounding state Vin_Gnd and the input voltage to output voltage state Vin_Vout, wherein the peak comparison result CMP_BO between the sensing signal Vsen and the peak ramp signal Vpk determines the duty cycle of the input voltage grounding state Vin_Gnd. Subsequently, when the sensing signal Vsen transitions to being between the valley ramp signal Vvl and the peak ramp signal Vpk, it indicates that the power conversion device 40 should first switch to buck-boost mode. At this point, when the duty cycle of the input voltage grounding state Vin_Gnd reaches the minimum fixed duty cycle Dmin, which results in limited voltage conversion efficiency, the ramp control circuit 4244 can (via the control signal CT_BO) control the ramp generator 4240 to add an offset signal to the generated ramp signal, to increase the difference between the sensing signal Vsen and the peak ramp signal Vpk (making it less likely for the sensing signal Vsen to reach the peak ramp signal Vpk), thereby extending the duty cycle of the input voltage grounding state Vin_Gnd.

After the ramp control circuit 4244 controls the ramp generator 4240 to add the offset signal to the ramp signal (i.e., the peak ramp signal Vpk includes the offset signal), when, in buck-boost mode, the sensing signal Vsen is greater than both the valley ramp signal Vvl and the peak ramp signal Vpk, and the ramp control circuit 4224 determines that the duty cycle of the input voltage grounding state Vin_Gnd again reaches the minimum fixed duty cycle Dmin, it indicates that the power conversion device 40 should switch to buck mode. At this point, the peak ramp signal Vpk with the added offset signal remains unchanged, while the valley ramp signal Vvl removes any previously added offset signal (as described above). Only when the mode indication signal BO indicates a transition from buck mode to boost mode (i.e., BO changes from 0 to 1) and the ramp control circuit 4244 determines that the duty cycle of the output voltage grounding state Gnd_Vout reaches the minimum fixed duty cycle Dmin, the ramp control circuit 4244 controls the ramp generator 4240 to remove the offset signal from the ramp signal, thereby restoring the level of the peak ramp signal Vpk.

In short, in the case where the power conversion device 40 switches from boost mode to buck-boost mode, when the duty cycle of the input voltage grounding state Vin_Gnd reaches the minimum fixed duty cycle Dmin, the peak ramp signal Vpk is added with an offset signal. This offset signal is removed from the peak ramp signal Vpk when the power conversion device 40 switches from buck mode back to buck-boost mode for the following transition to boost mode.

From the control mechanisms of the valley ramp signal generation module 422 and the peak ramp signal generation module 424, it is evident that the embodiment of the present invention dynamically adjusts the levels of the valley ramp signal Vvl and the peak ramp signal Vpk to appropriately extend the duty cycle of the output voltage grounding state Gnd_Vout or the input voltage grounding state Vin_Gnd, so as to effectively overcome the limitation of the minimum fixed duty cycle Dmin.

Additionally, besides appropriately extending the duty cycle of the output voltage grounding state Gnd_Vout or the input voltage grounding state Vin_Gnd in buck-boost mode, in one embodiment, the valley ramp signal generation module 422 and the peak ramp signal generation module 424 may also reduce the operating frequency of the power conversion device 40, i.e., reducing the switching frequency of the input voltage grounding state Vin_Gnd, the output voltage grounding state Gnd_Vout, and the input voltage to output voltage state Vin_Vout. For example, if the ramp generators 4220 and 4240 generate ramp signals based on a clock signal CLK, the ramp control circuits 4224 and 4244 may control the ramp generator 4220 to periodically skip at least one clock pulse of the clock signal CLK when the power conversion device 10 switches to buck-boost mode.

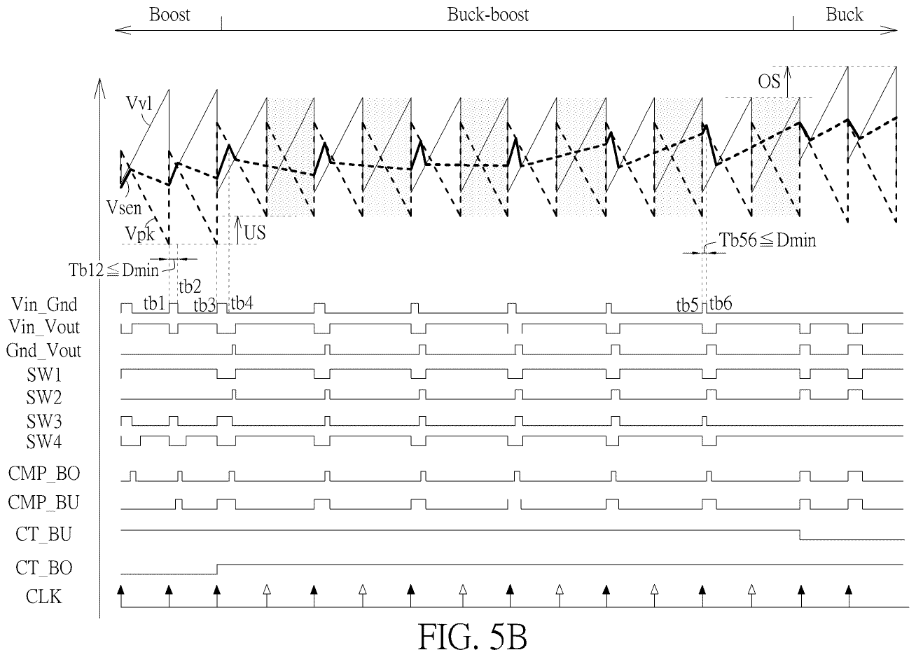

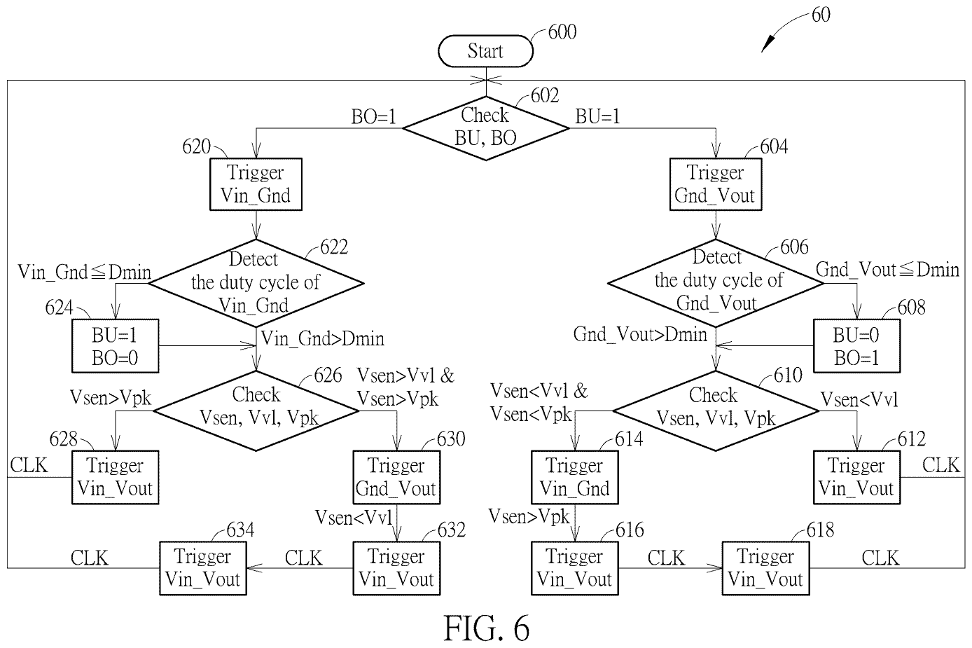

The operations of the power conversion device 40 for extending the duty cycles of the output voltage grounding state Gnd_Vout and the input voltage grounding state Vin_Gnd, as well as reducing the operating frequency, can be further understood by referring to FIG. 5A and FIG. 5B.

First, FIG. 5A is a schematic diagram of relevant signals when the power conversion device 40 switches from buck mode to buck-boost mode and then enters boost mode. The upper part of FIG. 5A shows the relative relationship between the sensing signal Vsen, the valley ramp signal Vvl, and the peak ramp signal Vpk (i.e., the input signals to the comparator module 426), while the lower part shows the duty cycle of the output voltage grounding state Gnd_Vout, the duty cycle of the input voltage grounding state Vin_Gnd, the control signals for the switching elements SW1-SW4, the peak comparison result CMP_BO, the valley comparison result CMP_BU, the control signals CT_BU and CT_BO, and the clock signal CLK. It is noted that, due to the low-side current sensing architecture of the power conversion device 40, the low-side current sensing module 12 can output the sensing signal Vsen only during the input voltage grounding state Vin_Gnd or the output voltage grounding state Gnd_Vout. Therefore, in FIG. 5A, the solid-line segments of the sensing signal Vsen represent the actual sensing signal Vsen output by the low-side current sensing module 12, while the dashed-line segments represent the virtual sensing signal Vsen not detected by the low-side current sensing module 12.

As shown in FIG. 5A, when the power conversion device 40 operates in buck mode, the switching elements SW1-SW4 periodically switch between the output voltage grounding state Gnd_Vout and the input voltage to output voltage state Vin_Vout. Subsequently, from time point ta1 to time point ta2, the comparator module 426 detects that the sensing signal Vsen is between the valley ramp signal Vvl and the peak ramp signal Vpk, indicating that the power conversion device 40 should switch to buck-boost mode. Meanwhile, the time period Ta12 from time point ta1 to time point ta2 is smaller than or equal to the minimum fixed duty cycle Dmin (Ta12≤Dmin), i.e., the duty cycle of the output voltage grounding state Gnd_Vout reaches the minimum fixed duty cycle Dmin. Consequently, the valley ramp signal generation module 422 adds an offset signal to the generated ramp signal, to reduce the level of the valley ramp signal Vvl by a level OS, such that the difference between the sensing signal Vsen and the valley ramp signal Vvl is increased, thereby extending the duty cycle of the output voltage grounding state Gnd_Vout. For example, in the next cycle, the duty cycle of the output voltage grounding state Gnd_Vout spans from time point ta3 to time point ta4, which is significantly longer than the time period Ta12 from time point ta1 to time point ta2, thereby improving voltage conversion efficiency.

On the other hand, FIG. 5B is a schematic diagram of relevant signals when the power conversion device 40 switches from boost mode to buck-boost mode and then enters buck mode, wherein the meanings of the signals are defined as described for FIG. 5A. As shown in FIG. 5B, when the power conversion device 40 operates in boost mode, the switching elements SW1-SW4 periodically switch between the input voltage grounding state Vin_Gnd and the input voltage to output voltage state Vin_Vout. Subsequently, from time point tb1 to time point tb2, the comparator module 426 detects that the sensing signal Vsen is between the valley ramp signal Vvl and the peak ramp signal Vpk, indicating that the power conversion device 40 should switch to buck-boost mode. Meanwhile, the time period Tb12 from time point tb1 to time point tb2 is smaller than or equal to the minimum fixed duty cycle Dmin (Tb12≤Dmin), i.e., the duty cycle of the input voltage grounding state Vin_Gnd reaches the minimum fixed duty cycle Dmin. Consequently, the peak ramp signal generation module 424 adds an offset signal to the generated ramp signal, to increase the level of the peak ramp signal Vpk by a level US, such that the difference between the sensing signal Vsen and the peak ramp signal Vpk is increased, thereby extending the duty cycle of the input voltage grounding state Vin_Gnd. For example, in the next cycle, the duty cycle of the input voltage grounding state Vin_Gnd spans from time point tb3 to time point tb4, which is significantly longer than the time period Tb12 from time point tb1 to time point tb2, thereby improving voltage conversion efficiency.

Regarding the timing for restoring the valley ramp signal Vvl and the peak ramp signal Vpk after adding the offset signals, please refer to FIG. 5A and FIG. 5B simultaneously. As shown in FIG. 5A, after the valley ramp signal Vvl includes the offset signal (at time point ta3) to reduce its level by OS, from time point ta5 to time point ta6, the sensing signal Vsen is smaller than both the valley ramp signal Vvl and the peak ramp signal Vpk, and the ramp control circuit 4244 determines that the duty cycle of the output voltage grounding state Gnd_Vout again reaches the minimum fixed duty cycle Dmin (i.e., the time period Ta56 from time point ta5 to time point ta6 is smaller than or equal to the minimum fixed duty cycle Dmin, Ta56≤Dmin). This indicates that the power conversion device 40 should switch to boost mode. At this point, the valley ramp signal Vvl maintains the reduced level OS, while the ramp control circuit 4244, via the control signal CT_BO, controls the ramp generator 4240 to remove the offset signal previously added to the peak ramp signal Vpk (e.g., in FIG. 5B, from time point tb3 to time point tb4, the peak ramp signal Vpk was increased by level US), to restore the level of the peak ramp signal Vpk. This continues until, from time point tb5 to tb6 of FIG. 5B, the sensing signal Vsen is greater than both the valley ramp signal Vvl and the peak ramp signal Vpk, and then the ramp control circuit 4224 determines that the duty cycle of the input voltage grounding state Vin_Gnd reaches the minimum fixed duty cycle Dmin (i.e., the time period Tb56 from time point tb5 to tb6 is smaller than or equal to the minimum fixed duty cycle Dmin, Tb56≤Dmin). This indicates that the power conversion device 40 should switch to buck mode. The ramp control circuit 4224, via the control signal CT_BU, controls the ramp generator 4220 to remove the offset signal previously added to the valley ramp signal Vvl (e.g., after time point tb6 in FIG. 5B, the valley ramp signal Vvl was increased by level OS), to restore the level of the valley ramp signal Vvl.

In short, when the power conversion device 40 switches from buck mode to buck-boost mode (time point ta3 in FIG. 5A), the offset signal added to the valley ramp signal Vvl is removed from the valley ramp signal Vvl when the power conversion device 40 enters boost mode (after time point ta6 in FIG. 5A, continuing until time point tb1 in FIG. 5B), switches to buck-boost mode (time point tb4 in FIG. 5B), and then enters buck mode (after time point tb6 in FIG. 5B). Similarly, when the power conversion device 40 switches from boost mode to buck-boost mode (time point tb3 in FIG. 5B), the offset signal added to the peak ramp signal Vpk is removed from the peak ramp signal Vpk when the power conversion device 40 enters buck mode (after time point tb6 in FIG. 5B, continuing until time point ta1 in FIG. 5A), switches to buck-boost mode (time point ta4 in FIG. 5A), and then enters boost mode (after time point ta6 in FIG. 5A).

Furthermore, as observed in FIG. 5A and FIG. 5B, the valley ramp signal Vvl and the peak ramp signal Vpk have the same phase, both synchronized with the clock signal CLK of the device. This phase alignment allows the valley ramp signal generation module 422 and the peak ramp signal generation module 424 to share the same timing base, so as to simplify the design and implementation of the ramp generators 4220 and 4240. For example, a single ramp generation circuit with a voltage offset mechanism can generate both signals without requiring additional phase adjustment circuits. This not only reduces hardware complexity and manufacturing costs but also enhances signal coordination and minimizes control errors due to phase mismatches. Those skilled in the art may further utilize this characteristic to adjust the amplitude or slope of the valley ramp signal Vvl and the peak ramp signal Vpk based on application requirements, for example, through adjustable resistors or digital control parameters to achieve dynamic adaptation for precise control in different operating modes.

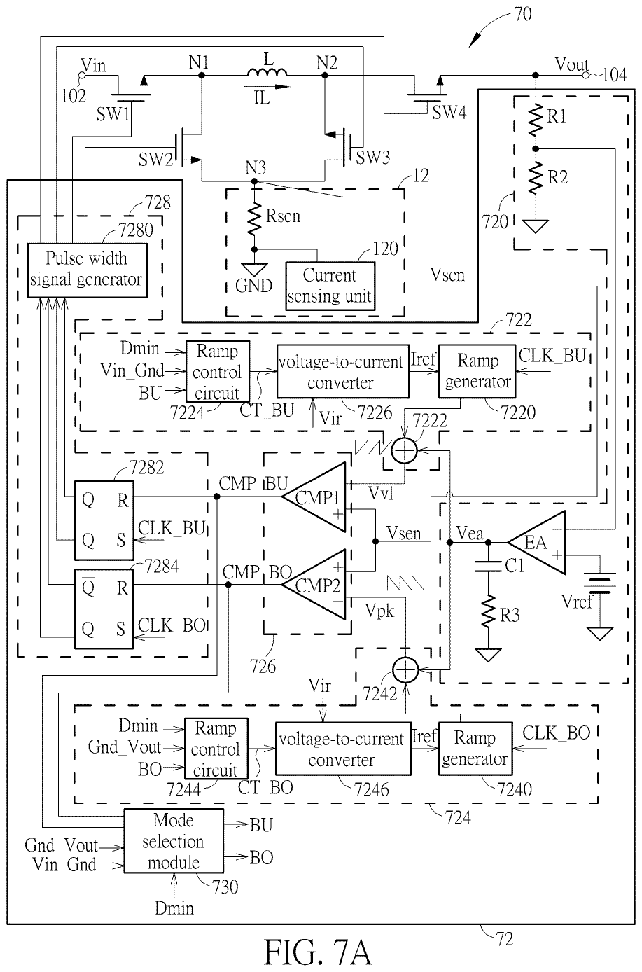

The operation process of the control circuit 42 can be summarized as an operational flow 60, as shown in FIG. 6. The operational flow 60 begins at step 600 and can be divided into two parts. In step 602, the valley ramp signal generation module 422 and the peak ramp signal generation module 424 check the mode indication signals BU and BO output by the mode selection module 430. In this example, when the mode indication signal BU is 1, the control circuit 42 executes the right half of the operational flow 60, i.e., steps 604-618; when the mode indication signal BO is 1, the control circuit 42 executes the left half of the operational flow 60, i.e., steps 620-634. First, when the mode indication signal BU is 1, the clock signal CLK triggers the duty cycle of the output voltage grounding state Gnd_Vout (step 604), during which the inductor is discharging. Next, the control circuit 42 detects the duty cycle of the output voltage grounding state Gnd_Vout (step 606). When the duty cycle of the output voltage grounding state Gnd_Vout reaches the minimum fixed duty cycle Dmin (i.e., the duty cycle of the output voltage grounding state Gnd_Vout is smaller than or equal to the minimum fixed duty cycle Dmin, denoted as Gnd_Vout≤Dmin in FIG. 6), the power conversion device 40 should switch to boost mode, so the mode indication signal BU is set to 0, and the mode indication signal BO is set to 1 (step 608). Regardless of whether the duty cycle of the output voltage grounding state Gnd_Vout reaches the minimum fixed duty cycle Dmin, the control circuit 42 checks the relationship between the sensing signal Vsen, the valley ramp signal Vvl, and the peak ramp signal Vpk (step 610). When the sensing signal Vsen is smaller than the valley ramp signal Vvl, the control circuit 42 turns off the output voltage grounding state Gnd_Vout, activates the input voltage to output voltage state Vin_Vout (step 612), and proceeds to the next cycle based on the trigger of the clock signal CLK. Additionally, to determine the timing of mode switching, when the control circuit 42 detects that the sensing signal Vsen is smaller than the valley ramp signal Vvl, the control circuit 42 immediately samples the position of the sensing signal Vsen relative to the peak ramp signal Vpk. When the sensing signal Vsen is detected to be smaller than the peak ramp signal Vpk, the control circuit 42 activates the input voltage grounding state Vin_Gnd instead of the input voltage to output voltage state Vin_Vout (step 614), indicating that the power conversion device 40 has entered buck-boost mode. Subsequently, when the sensing signal Vsen is greater than the peak ramp signal Vpk, the input voltage to output voltage state Vin_Vout is activated (step 616), the power conversion device 40 skips one cycle of the clock signal CLK and maintains the input voltage to output voltage state Vin_Vout during this period (step 618), thereby achieving a frequency reduction effect. Then, the power conversion device 40 proceeds to the next cycle based on the trigger of the clock signal CLK.

Correspondingly, if the mode indication signal BO is 1, the clock signal CLK triggers the duty cycle of the input voltage grounding state Vin_Gnd (step 620), during which the inductor is charging. Next, the control circuit 42 detects the duty cycle of the input voltage grounding state Vin_Gnd (step 622). When the duty cycle of the input voltage grounding state Vin_Gnd reaches the minimum fixed duty cycle Dmin (i.e., the duty cycle of the input voltage grounding state Vin_Gnd is smaller than or equal to the minimum fixed duty cycle Dmin, denoted as Vin_Gnd≤Dmin in FIG. 6), the power conversion device 40 should switch to buck mode, so the mode indication signal BO is set to 0, and the mode indication signal BU is set to 1 (step 624). Regardless of whether the duty cycle of the input voltage grounding state Vin_Gnd reaches the minimum fixed duty cycle Dmin, the control circuit 42 checks the relationship between the sensing signal Vsen, the valley ramp signal Vvl, and the peak ramp signal Vpk (step 626). When the sensing signal Vsen is greater than the peak ramp signal Vpk, the control circuit 42 turns off the input voltage grounding state Vin_Gnd, activates the input voltage to output voltage state Vin_Vout (step 628), and proceeds to the next cycle based on the trigger of the clock signal CLK. Additionally, to determine the timing of mode switching, when the control circuit 42 detects that the sensing signal Vsen is greater than the peak ramp signal Vpk, the control circuit 42 immediately samples the position of the sensing signal Vsen relative to the valley ramp signal Vvl. If the sensing signal Vsen is detected to be greater than the valley ramp signal Vvl, the control circuit 42 activates the output voltage grounding state Gnd_Vout instead of the input voltage to output voltage state Vin_Vout (step 630), indicating that the power conversion device 40 has entered buck-boost mode. Subsequently, when the sensing signal Vsen is smaller than the peak ramp signal Vpk, the input voltage to output voltage state Vin_Vout is activated (step 632), the power conversion device 40 skips one cycle of the clock signal CLK and maintains the input voltage to output voltage state Vin_Vout during this period (step 634), thereby achieving a frequency reduction effect. Then, the power conversion device 40 proceeds to the next cycle based on the trigger of the clock signal CLK.

The detailed description of the operational flow 60 can be better understood in conjunction with the relevant signals in FIG. 5A and FIG. 5B.

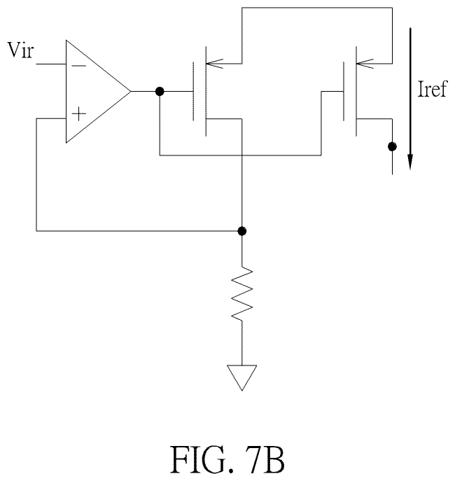

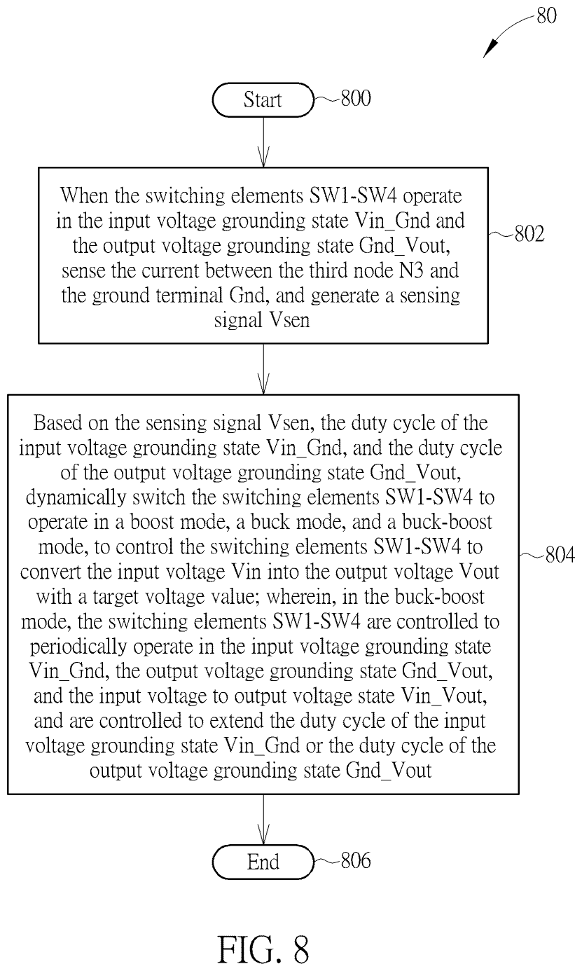

It should be noted that the power conversion device 40 in FIG. 4 is an embodiment of the present invention, and those skilled in the art may make various modifications without being limited thereto. For example, please refer to FIG. 7A, which is a schematic diagram of a power conversion device 70 according to an embodiment of the present invention. The power conversion device 70 is derived from the power conversion device 40, so identical components are denoted by the same symbols. A control circuit 72 of the power conversion device 70 comprises an error amplification module 720, a valley ramp signal generation module 722, a peak ramp signal generation module 724, a comparator module 726, a driver module 728, and a mode selection module 730, respectively configured to implement the error amplification module 420, the valley ramp signal generation module 422, the peak ramp signal generation module 424, the comparator module 426, the driver module 428, and the mode selection module 430 of the control circuit 42, with their detailed operations as described above. The error amplification module 720 comprises an error amplifier EA, resistors R1-R3, a capacitor C1, and a reference voltage generator Vref. The valley ramp signal generation module 722 comprises a ramp generation circuit 7220, an adder 7222, a ramp control circuit 7224, and a voltage-to-current converter 7226, while the peak ramp signal generation module 724 comprises a ramp generation circuit 7240, an adder 7242, a ramp control circuit 7244, and a voltage-to-current converter 7246. The ramp generation circuit 7220 and the voltage-to-current converter 7226 are configured to implement the ramp generator 4220, and the ramp control circuit 7224 is configured to implement the ramp control circuit 4224, to control the ramp generation circuit 7220 via the voltage-to-current converter 7226 to add an offset signal as needed. The ramp generator 7220 also generates a clock signal based on the clock signal CLK_BU, such that the ramp generator 7220 may be controlled to skip clock pulses (as detailed above). Similarly, the ramp generation circuit 7240 and the voltage-to-current converter 7246 are configured to implement the ramp generator 4240, and the ramp control circuit 7244 is configured to implement the ramp control circuit 4244, to control the ramp generation circuit 7240 via the voltage-to-current converter 7246 to add an offset signal as needed. The ramp generator 7240 also generates a clock signal based on the clock signal CLK_BO, such that the ramp generator 7240 may be controlled to skip clock pulses (as detailed above). For example, the ramp control circuit 7224 compares the duty cycle of the input voltage grounding state Vin_Gnd with the minimum fixed duty cycle Dmin and timely outputs the control signal CT_BU, to control the voltage-to-current converter 7226 to convert a voltage Vir to a current Iref, altering the level of the ramp signal generated by the ramp generation circuit 7220. Similarly, the ramp control circuit 7244 compares the duty cycle of the output voltage grounding state Gnd_Vout with the minimum fixed duty cycle Dmin and timely outputs the control signal CT_BO, to control the voltage-to-current converter 7246 to convert a voltage Vir to a current Iref, and alter the level of the ramp signal generated by the ramp generation circuit 7240. Please refer to FIG. 7B, which is a schematic diagram of a voltage-to-current converter. The voltage-to-current converter in FIG. 7B can implement the voltage-to-current converters 7226 and 7246, to convert the voltage Vir to the current Iref. The adder 7222 is configured to implement the adder 4222, which adds the ramp signal generated by the ramp generation circuit 7220 to the error amplification signal Vea to generate the valley ramp signal Vvl. Similarly, the adder 7242 is configured to implement the adder 4242, which adds the ramp signal generated by the ramp generation circuit 7240 to the error amplification signal Vea to generate the peak ramp signal Vpk.

The comparator module 726 comprises comparators CMP1 and CMP2. One input terminal (e.g., the positive input terminal (+)) of the comparator CMP1 receives the sensing signal Vsen from the low-side current sensing module 12, and the other input terminal thereof (e.g., the negative input terminal (−)) receives the valley ramp signal Vvl from the valley ramp signal generation module 722. One input terminal (e.g., the positive input terminal (+)) of the comparator CMP2 receives the sensing signal Vsen from the low-side current sensing module 12, and the other input terminal thereof (e.g., the negative input terminal (−)) receives the peak ramp signal Vpk from the peak ramp signal generation module 724. The driver module 728 comprises a pulse width signal generator 7280 and D-type flip-flops 7282 and 7284.

Additionally, those skilled in the art may make various modifications to suit specific application requirements or implementations. For example, the switching elements SW1-SW4 may be metal-oxide-semiconductor field-effect transistors (MOSFETs), bipolar junction transistors (BJTs), or insulated-gate bipolar transistors (IGBTs), and selected based on the power requirements, switching frequency, or cost considerations of the power conversion device. The inductor L may be an air-core inductor or a ferrite-core inductor, and adjusted based on the required inductance value and current capacity. The resistor Rsen in the low-side current sensing module 12 may be replaced with a Hall-effect sensor or a current transformer to enhance current sensing accuracy or reduce power consumption. The implementation of the control circuits 14, 42, or 72 is not limited to a single integrated logic circuit and may be composed of discrete components or integrated into a microcontroller (MCU) or digital signal processor (DSP) to implement more complex control algorithms. Furthermore, the ramp generators 4220 and 4240 in the valley ramp signal generation module 422 and the peak ramp signal generation module 424 may use analog circuits to generate sawtooth waves or digitally generate pulse-width modulation (PWM) signals to accommodate different system architectures. These variations do not depart from the core spirit of the present invention and can be flexibly adjusted based on practical application scenarios.

Moreover, although the mode indication signals BU and BO are described as separate signals, they may be different levels of a single signal, for example, using a high level (e.g., logic 1) of a single mode indication signal to indicate buck mode and a low level (e.g., logic 0) to indicate boost mode, so as to simplify the control circuit design. The generation of the valley ramp signal Vvl and the peak ramp signal Vpk is not limited to analog ramp generators and may be achieved through digital counters combined with digital-to-analog converters (DACs), and the slopes or offsets of the valley ramp signal Vvl and the peak ramp signal Vpk may be dynamically adjusted based on the clock signal CLK. Additionally, the error amplification signal Vea may undergo filtering to reduce high-frequency noise impact on the control loop or adjust its gain based on application requirements. These signal-related variations can be adjusted and implemented by those skilled in the art based on system performance requirements or hardware constraints without departing from the technical scope of the present invention.

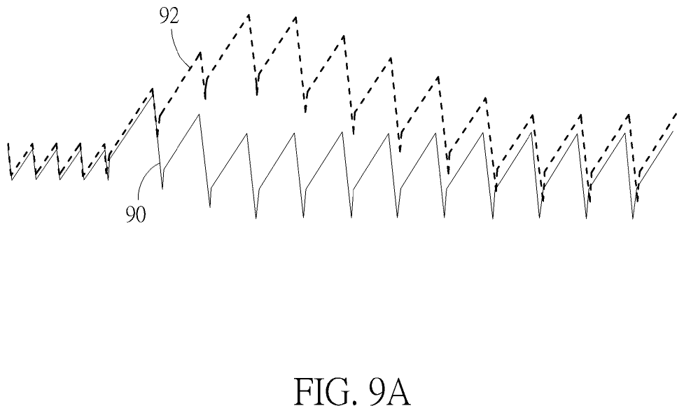

On the other hand, the operation of the power conversion device 40 in FIG. 4 can be summarized as a control flow 80, as shown in FIG. 8. The control flow 80 comprises the following steps:

Step 800: Start.

Step 802: When the switching elements SW1-SW4 operate in the input voltage grounding state Vin_Gnd and the output voltage grounding state Gnd_Vout, sense the current between the third node N3 and the ground terminal Gnd, and generate a sensing signal Vsen.

Step 804: Based on the sensing signal Vsen, the duty cycle of the input voltage grounding state Vin_Gnd, and the duty cycle of the output voltage grounding state Gnd_Vout, dynamically switch the switching elements SW1-SW4 to operate in a boost mode, a buck mode, and a buck-boost mode, to control the switching elements SW1-SW4 to convert the input voltage Vin into the output voltage Vout with a target voltage value; wherein, in the buck-boost mode, the switching elements SW1-SW4 are controlled to periodically operate in the input voltage grounding state Vin_Gnd, the output voltage grounding state Gnd_Vout, and the input voltage to output voltage state Vin_Vout, and are controlled to extend the duty cycle of the input voltage grounding state Vin_Gnd or the duty cycle of the output voltage grounding state Gnd_Vout.

Step 806: End.

The detailed operation of the control flow 80 can be referred to the above description and is not repeated here.

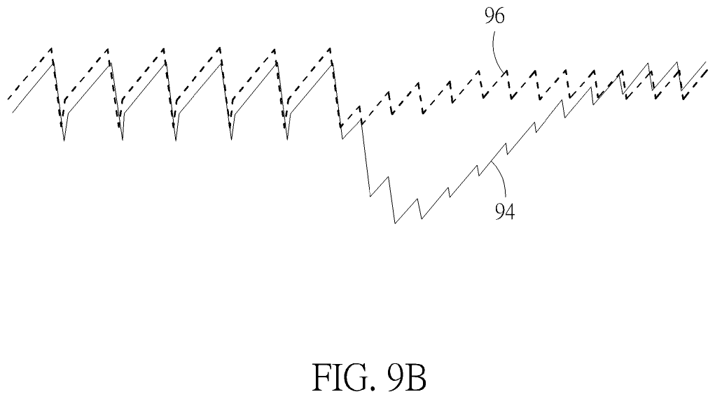

From the above, it is evident that the present invention, by dynamically adjusting the levels of the valley ramp signal Vvl and the peak ramp signal Vpk, effectively overcomes the limitation of the minimum duty cycle, enhances system efficiency, reduces switching losses, and achieves smooth transitions between modes. For example, referring to FIGS. 9A and 9B, FIG. 9A and FIG. 9B are comparative schematic diagrams of inductor current. FIG. 9A illustrates the inductor current variation when the power conversion device switches from buck mode to buck-boost mode, with and without the duty cycle extension mechanism of the present invention, corresponding to FIG. 5A. A solid-line curve 90 represents the inductor current variation with the duty cycle extension mechanism of the present invention, while a dashed-line curve 92 represents the inductor current variation without this mechanism. The comparison shows that, when switching from buck mode to buck-boost mode, the inductor current variation with the duty cycle extension mechanism of the present invention is smoother, to achieve smooth mode transitions. Similarly, FIG. 9B illustrates the inductor current variation when the power conversion device switches from boost mode to buck-boost mode, with and without the duty cycle extension mechanism of the present invention, corresponding to FIG. 5B. A solid-line curve 94 represents the inductor current variation with the duty cycle extension mechanism of the present invention, while a dashed-line curve 96 represents the inductor current variation without this mechanism. The comparison shows that, when switching from boost mode to buck-boost mode, the inductor current variation with the duty cycle extension mechanism of the present invention is smoother, to achieve smooth mode transitions.

In the prior art, when a power conversion device switches between buck mode, boost mode, and buck-boost mode, the limitation of the minimum duty cycle often leads to reduced voltage conversion efficiency, increased switching losses, and even electromagnetic interference issues, making it difficult to achieve smooth mode transitions and stable output voltage. In contrast, the present invention, by dynamically adjusting the levels of the valley ramp signal and the peak ramp signal, appropriately extends the duty cycle of the input voltage grounding state or the output voltage grounding state, and combines this with a reduction in operating frequency, which can effectively overcome the minimum duty cycle limitation, enhance system efficiency, reduce switching losses, and achieve smooth mode transitions.

In summary, the present invention provides an efficient and stable power conversion device and a control method thereof. Through a low-side current sensing architecture and an innovative control mechanism, the present invention not only maintains the stability of the output voltage but also reduces electromagnetic interference and system losses, making it suitable for various application scenarios with different input and output voltage requirements, offering significant technical advantages and practical value.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power conversion device, comprising:
an input terminal, configured to receive an input voltage;
an output terminal, configured to provide an output voltage;
a first, a second, a third, and a fourth switching elements, wherein the first switching element is connected between the input terminal and the second switching element, the second switching element is connected to the third switching element, the fourth switching element is connected between the third switching element and the output terminal, a connection between the first and second switching elements forms a first node, a connection between the third and fourth switching elements forms a second node, and a connection between the second and third switching elements forms a third node;
an inductor, connected between the first node and the second node;
a low-side current sensing module, disposed between the third node and a ground terminal, configured to sense a current between the third node and the ground terminal when the first to fourth switching elements operate in an input voltage grounding state and an output voltage grounding state, and to generate a sensing signal; and
a control circuit, coupled to the low-side current sensing module, the output terminal, and the first to fourth switching elements, configured to dynamically switch the first to fourth switching elements to operate in a boost mode, a buck mode, and a buck-boost mode based on the sensing signal, a duty cycle of the input voltage grounding state, and a duty cycle of the output voltage grounding state, thereby controlling the first to fourth switching elements to convert the input voltage into the output voltage with a target voltage value;
wherein, in the buck-boost mode, the control circuit controls the first to fourth switching elements to periodically operate in the input voltage grounding state, the output voltage grounding state, and an input voltage to output voltage state, and extends the duty cycle of the input voltage grounding state or the duty cycle of the output voltage grounding state.

2. The power conversion device of claim 1, wherein the control circuit comprises:
an error amplification module, configured to generate an error amplification signal based on the output voltage;
a valley ramp signal generation module, configured to generate a valley ramp signal based on the error amplification signal, the duty cycle of the input voltage grounding state, and a mode indication signal;
a peak ramp signal generation module, configured to generate a peak ramp signal based on the error amplification signal, the duty cycle of the output voltage grounding state, and the mode indication signal;
a comparator module, coupled to the low-side current sensing module, the valley ramp signal generation module, and the peak ramp signal generation module, configured to compare the sensing signal with the valley ramp signal to generate a valley comparison result, and to compare the sensing signal with the peak ramp signal to generate a peak comparison result;
a driver module, coupled to the comparator module and the first to fourth switching elements, configured to control on or off states of the first to fourth switching elements based on the valley comparison result and the peak comparison result; and
a mode selection module, configured to generate the mode indication signal based on the duty cycle of the input voltage grounding state, the duty cycle of the output voltage grounding state, the valley comparison result, and the peak comparison result.

3. The power conversion device of claim 2, wherein the valley ramp signal generation module comprises:
a ramp generator, configured to generate a ramp signal;
an adder, coupled to the ramp generator, the error amplification module, and the comparator module, configured to add the ramp signal to the error amplification signal to generate the valley ramp signal, and output the valley ramp signal to the comparator module; and
a ramp control circuit, coupled to the ramp generator and the mode selection module, configured to control the ramp generator to add an offset signal to the ramp signal when the mode indication signal indicates a transition from the buck mode to the boost mode, thereby reducing a level of the valley ramp signal to extend the duty cycle of the output voltage grounding state.

4. The power conversion device of claim 3, wherein the mode selection module, in the buck mode, changes the mode indication signal from indicating the buck mode to indicating the boost mode when the duty cycle of the output voltage grounding state reaches a minimum fixed duty cycle and the valley comparison result and the peak comparison result indicate that the sensing signal is between the valley ramp signal and the peak ramp signal.

5. The power conversion device of claim 3, wherein when the mode indication signal indicates a transition from the boost mode to the buck mode and the duty cycle of the input voltage grounding state reaches the minimum fixed duty cycle, the ramp control circuit controls the ramp generator to remove the offset signal from the ramp signal to restore the level of the valley ramp signal.

6. The power conversion device of claim 3, wherein the ramp generator generates the ramp signal based on a clock signal, and the ramp control circuit is further configured to control the ramp generator to periodically skip at least one clock pulse of the clock signal when the mode indication signal indicates the transition from the buck mode to the boost mode, thereby reducing a switching frequency of the input voltage grounding state, the output voltage grounding state, and the input voltage to output voltage state.

7. The power conversion device of claim 2, wherein the peak ramp signal generation module comprises:
a ramp generator, configured to generate a ramp signal;
an adder, coupled to the ramp generator, the error amplification module, and the comparator module, configured to add the ramp signal to the error amplification signal to generate the peak ramp signal, and output the peak ramp signal to the comparator module; and
a ramp control circuit, coupled to the ramp generator and the mode selection module, configured to control the ramp generator to add an offset signal to the ramp signal when the mode indication signal indicates a transition from the boost mode to the buck mode, thereby increasing a level of the peak ramp signal to extend the duty cycle of the input voltage grounding state.

8. The power conversion device of claim 7, wherein the mode selection module, in the boost mode, changes the mode indication signal from indicating the boost mode to indicating the buck mode when the duty cycle of the input voltage grounding state reaches the minimum fixed duty cycle, and the valley comparison result and the peak comparison result indicate that the sensing signal is between the valley ramp signal and the peak ramp signal.

9. The power conversion device of claim 7, wherein when the mode indication signal indicates a transition from the buck mode to the boost mode and the duty cycle of the output voltage grounding state reaches the minimum fixed duty cycle, the ramp control circuit controls the ramp generator to remove the offset signal from the ramp signal to restore the level of the peak ramp signal.

10. The power conversion device of claim 7, wherein the ramp generator generates the ramp signal based on a clock signal, and the ramp control circuit is further configured to control the ramp generator to periodically skip at least one clock pulse of the clock signal when the mode indication signal indicates the transition from the boost mode to the buck mode, thereby reducing a switching frequency of the input voltage grounding state, the output voltage grounding state, and the input voltage to output voltage state.

11. A control method for a power conversion device, wherein the power conversion device comprises an input terminal configured to receive an input voltage, an output terminal configured to provide an output voltage, a first to a fourth switching elements, wherein the first switching element is connected between the input terminal and the second switching element, the second switching element is connected to the third switching element, the fourth switching element is connected between the third switching element and the output terminal, a connection between the first and second switching elements forms a first node, a connection between the third and fourth switching elements forms a second node, and a connection between the second and third switching elements forms a third node, and an inductor connected between the first node and the second node, the control method comprising:
sensing a current between the third node and a ground terminal when the first to fourth switching elements operate in an input voltage grounding state and an output voltage grounding state, and generating a sensing signal; and
dynamically switching the first to fourth switching elements to operate in a boost mode, a buck mode, and a buck-boost mode based on the sensing signal, a duty cycle of the input voltage grounding state, and a duty cycle of the output voltage grounding state, thereby controlling the first to fourth switching elements to convert the input voltage into the output voltage with a target voltage value;
wherein, in the buck-boost mode, the first to fourth switching elements are controlled to periodically operate in the input voltage grounding state, the output voltage grounding state, and an input voltage to output voltage state, and are controlled to extend the duty cycle of the input voltage grounding state or the duty cycle of the output voltage grounding state.

12. The control method of claim 11, further comprising:
generating an error amplification signal based on the output voltage;
generating a valley ramp signal based on the error amplification signal, the duty cycle of the input voltage grounding state, and a mode indication signal;
generating a peak ramp signal based on the error amplification signal, the duty cycle of the output voltage grounding state, and the mode indication signal;
comparing the sensing signal with the valley ramp signal to generate a valley comparison result, and comparing the sensing signal with the peak ramp signal to generate a peak comparison result;
controlling on or off states of the first to fourth switching elements based on the valley comparison result and the peak comparison result; and
generating the mode indication signal based on the duty cycle of the input voltage grounding state, the duty cycle of the output voltage grounding state, the valley comparison result, and the peak comparison result.

13. The control method of claim 12, wherein the step of generating the valley ramp signal based on the error amplification signal, the duty cycle of the output voltage grounding state, and the mode indication signal comprises:
generating a ramp signal;
adding the ramp signal to the error amplification signal to generate the valley ramp signal; and
adding an offset signal to the ramp signal when the mode indication signal indicates a transition from the buck mode to the boost mode, thereby reducing a level of the valley ramp signal to extend the duty cycle of the output voltage grounding state.

14. The control method of claim 13, wherein, in the buck mode, when the duty cycle of the output voltage grounding state reaches a minimum fixed duty cycle and the valley comparison result and the peak comparison result indicate that the sensing signal is between the valley ramp signal and the peak ramp signal, the mode indication signal changes from indicating the buck mode to indicating the boost mode.

15. The control method of claim 13, further comprising removing the offset signal from the ramp signal to restore the level of the valley ramp signal when the mode indication signal indicates a transition from the boost mode to the buck mode and the duty cycle of the input voltage grounding state reaches the minimum fixed duty cycle.

16. The control method of claim 13, wherein the ramp signal is generated based on a clock signal, and the control method further comprises periodically skipping at least one clock pulse of the clock signal when the mode indication signal indicates the transition from the buck mode to the boost mode, thereby reducing a switching frequency of the input voltage grounding state, the output voltage grounding state, and the input voltage to output voltage state.

17. The control method of claim 12, wherein the step of generating the peak ramp signal based on the error amplification signal, the duty cycle of the input voltage grounding state, and the mode indication signal comprises:
generating a ramp signal;
adding the ramp signal to the error amplification signal to generate the peak ramp signal; and
adding an offset signal to the ramp signal when the mode indication signal indicates a transition from the boost mode to the buck mode, thereby increasing a level of the peak ramp signal to extend the duty cycle of the input voltage grounding state.

18. The control method of claim 17, wherein, in the boost mode, when the duty cycle of the input voltage grounding state reaches the minimum fixed duty cycle and the valley comparison result and the peak comparison result indicate that the sensing signal is between the valley ramp signal and the peak ramp signal, the mode indication signal changes from indicating the boost mode to indicating the buck mode.

19. The control method of claim 17, further comprising removing the offset signal from the ramp signal to restore the level of the peak ramp signal when the mode indication signal indicates a transition from the buck mode to the boost mode and the duty cycle of the output voltage grounding state reaches the minimum fixed duty cycle.

20. The control method of claim 17, wherein the ramp signal is generated based on a clock signal, and the control method further comprises periodically skipping at least one clock pulse of the clock signal when the mode indication signal indicates the transition from the boost mode to the buck mode, thereby reducing a switching frequency of the input voltage grounding state, the output voltage grounding state, and the input voltage to output voltage state.
